(19) United States
(12) Patent Application Publication
(10) Pub. No.: US 2003/0069978 A1
(43) Pub. Date: Apr. 10, 2003

(54) Systems and methods for providing location-specific services to users

(76) Inventors: Darrel D. Cherry, Meridian, ID (US); James Clough, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/974,547

(22) Filed: Oct. 10, 2001

(51) Int. Cl. G06F 15/16

(52) U.S. Cl. 709/227

(57) ABSTRACT

Information systems for providing information to a user are provided. In this regard, a representative information system includes a location-specific input system that is configured to communicate with a communication network. The location-specific input system also is configured to receive an input from a user, determine a location of the user, and enable information corresponding to the input of the user and the location of the user to be provided to the communication network. Methods and other systems also are provided.

### BACKGROUND OF THE INVENTION

1. Field of the Invention

The present invention relates to systems and methods for providing information to a user based, at least in part, upon the location of the user.

2. Description of the Related Art

Portable computing devices, such as Internet-capable phones, personal digital assistants and laptops, are seemingly becoming more commonplace every day. Although these devices are capable of performing various time-saving functions, they are not without shortcomings. For instance, due to the relatively small size of these devices, input/output components incorporated into these devices also typically are quite small. More specifically, a display screen included in such a device typically is small and, therefore, is not capable of simultaneously displaying a large amount of information. As a result, information oftentimes is provided over multiple screens of data through which a user must navigate.

Users also may experience difficulty when attempting to enter information into portable computing devices. This can be due to a small number of actuators provided by a portable computing device and/or the necessity of a user to make multiple entries so that the user can navigate through the multiple screens of information. Thus, the combination of information being displayed over multiple screens and difficulty in entering information can render the experience of attempting to browse through a relatively large volume of information via a portable computing device less than ideal.

### SUMMARY OF THE INVENTION

Briefly described, the present invention involves systems and methods for providing information to a user via a communication network. In this regard, embodiments of the invention can include an information system that incorporates one or more of a services system and an input system. Preferably, the services system and/or input system function so that a user can be provided with information, which can be based, at least partially, on the location of the user. In those embodiments adapted for use with portable computing devices, such an information system can enhance the convenience of using portable computing devices.

A representative information system includes a location-specific input system that is configured to communicate with a communication network. The location-specific input system also is configured to receive an input from a user, determine a location of the user, and enable information corresponding to the input of the user and the location of the user to be provided to the communication network.

Some embodiments of the information system can include a location-specific input system that is configured to receive information via the communication network, determine a location of the user, and prevent information failing to correspond to the location of the user from being provided to the user.

Other embodiments of the information system can incorporate a location-specific services system that is configured to communicate with a communication network. Such a location-specific services system can be configured to receive information from a user via the communication network, determine a location of the user, and provide information which corresponds to the location of the user to the user via the communication network.

Embodiments of the invention also may be construed as providing methods for providing information to a user via a communication network. In this regard, a representative method includes: providing a portable computing device; receiving an input from a user via the portable computing device; automatically determining a location of the user; and enabling information corresponding to the input of the user and the location of the user to be provided to the communication network via the portable computing device.

An alternative method includes: receiving an input from a user; determining a location of the user; and providing information corresponding to the input of the user and the location of the user to the user via the communication network.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a representative embodiment of the information system of the present invention.

FIG. 2 is a schematic diagram depicting a computer or processor-based device that may be utilized to implement the location-specific input system of FIG. 1.

FIG. 3 is a flowchart depicting functionality of a representative embodiment of the location-specific input system of FIG. 2.

FIG. 4 is a flowchart depicting functionality of another representative embodiment of the location-specific input system of FIG. 2.

FIG. 5 is a schematic diagram depicting a computer or processor-based device that may be utilized to implement the location-specific services system of FIG. 1.

FIG. 6 is a flowchart depicting functionality of a representative embodiment of the location-specific services system of FIG. 5.

FIG. 7 is a flowchart depicting functionality of another representative embodiment of the location-specific services system of FIG. 5.

### DETAILED DESCRIPTION

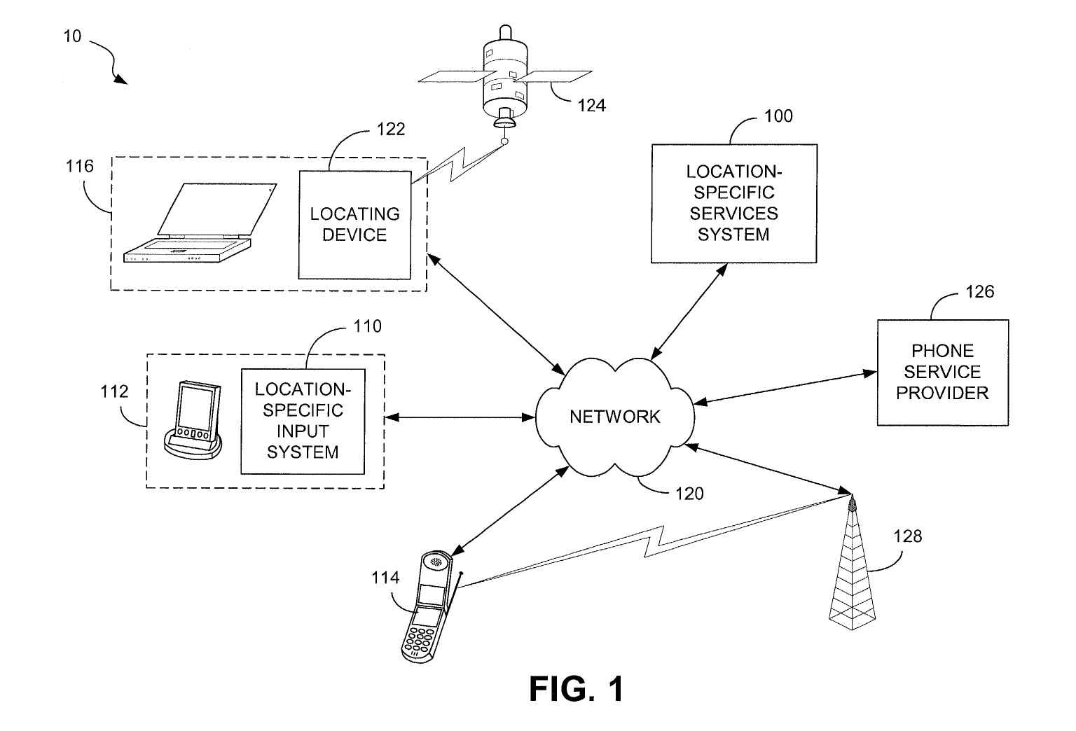

Referring now to the figures, wherein like reference numerals indicate corresponding components throughout the several views, FIG. 1 depicts a representative embodiment of an information system 10 of the present invention. As shown in FIG. 1, information system 10 can include a location-specific services system 100 (“services system”) and a location-specific input system 100 (“input system”). As described in greater detail hereinafter, the services system and input system interact so that a user can be provided with information. Preferably, such information is based, at least partially, on the location of the user. As should become apparent, this functionality can enhance the convenience of using portable computing devices, e.g., an Internet-capable cell phone.

Services system 100 of FIG. 1 is adapted to provide information to a user. In some embodiments, the information provided by the services system is specifically selected based on the user's location. In these embodiments, a user accessing the services system, such as via a portable computing device, may not need to enter location information into their portable computing device in order to receive information, which corresponds to the user's location, from the services system. Preferably, as described herein, the input system automatically provides information corresponding to the user's location to the services system. This potentially alleviates the need for the user to enter location information or browse for information corresponding to the user's location when communicating with the services system.

The ability of a user to receive location-specific information via a portable computing device without having to input location information manually can significantly enhance the efficiency and/or convenience of using portable computing devices. As is known, such portable computing devices typically provide relatively small display screens for viewing information and/or relatively few actuators for performing various functions, such as entering information. Thus, when a user desires information relevant to a particular location, e.g., the user's current location, it is oftentimes difficult and/or tedious for the user to enter the location information into the portable computing device.

By way of example, if a user desires to purchase movie tickets for a particular movie and the user is unsure as to which theater(s) is showing the movie, the user could browse information provided by a movie ticket purchasing service via a portable computing device. In order to identify an appropriate theater, the user typically would provide the movie ticket purchasing service with a location, e.g., the city, corresponding to the desired theater location via the portable computing device. Due to the limited display screen space of such a device, the user may be required to scroll through various menus and/or manually enter the location via a keypad, for example, in order to provide the location information to the services system.

By using an embodiment of the services system associated with a movie ticket purchasing service, a user desiring movie tickets may only need to enter information corresponding to the desired movie. More specifically, the location of the user could be provided automatically to the services system, such as via an input system associated with the user's portable computing device. The services system could be adapted to receive the information corresponding to the location of the user and use this information for determining which theater would be suitable, e.g., the closest theater to the user.

As shown in FIG. 1, various types of portable computing devices can be used to implement input system 110. For instance, portable computing devices, such as personal digital assistant (PDA) 112, phone 114, and laptop 116, can use the input system. Typically, the device employing the input system facilitates communication between the input system and the services system. More specifically, communication of the input system with the services system can be accomplished via a communication network 120, i.e., a network that the portable computing device is configured to utilize. In this regard, network 120 may be any type of communication network employing any network topology, transmission medium, or network protocol. For example, network 120 may be any public or private packet-switched or other data network, including the Internet, circuit-switched networks, such as the public switched telephone network (PSTN), wireless network, or any other desired communications infrastructure and/or combination of infrastructures.

Preferably, the input system communicates with a locating device 122. The locating device is configured to facilitate determining the position of the portable computing device with which it is associated. For example, in some embodiments, a Global Positioning System (GPS) receiver can be associated with the portable computing device. In such an embodiment, the GPS receiver can receive position information from one or more GPS system satellites, e.g., satellite 124 of FIG. 1. The information can then be provided to the input system.

In other embodiments, the input system could utilize location information used by other devices and/or systems. For instance, embodiments of the input system could be configured to determine a user's location based on the current communication cell occupied by the user, i.e., the cell location corresponding to the user's cell phone. In such an embodiment, the input system could query the user's cell phone service provider 126 to determine the user's cell location. If, however, the device implementing the input system is a cell phone, the cell phone could be adapted to receive cell information corresponding to the current cell, such as from cell tower 128, and provide the information to the input system.

Input system 110 can be implemented in software, firmware, hardware, or a combination thereof. When implemented in hardware, input system 110 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

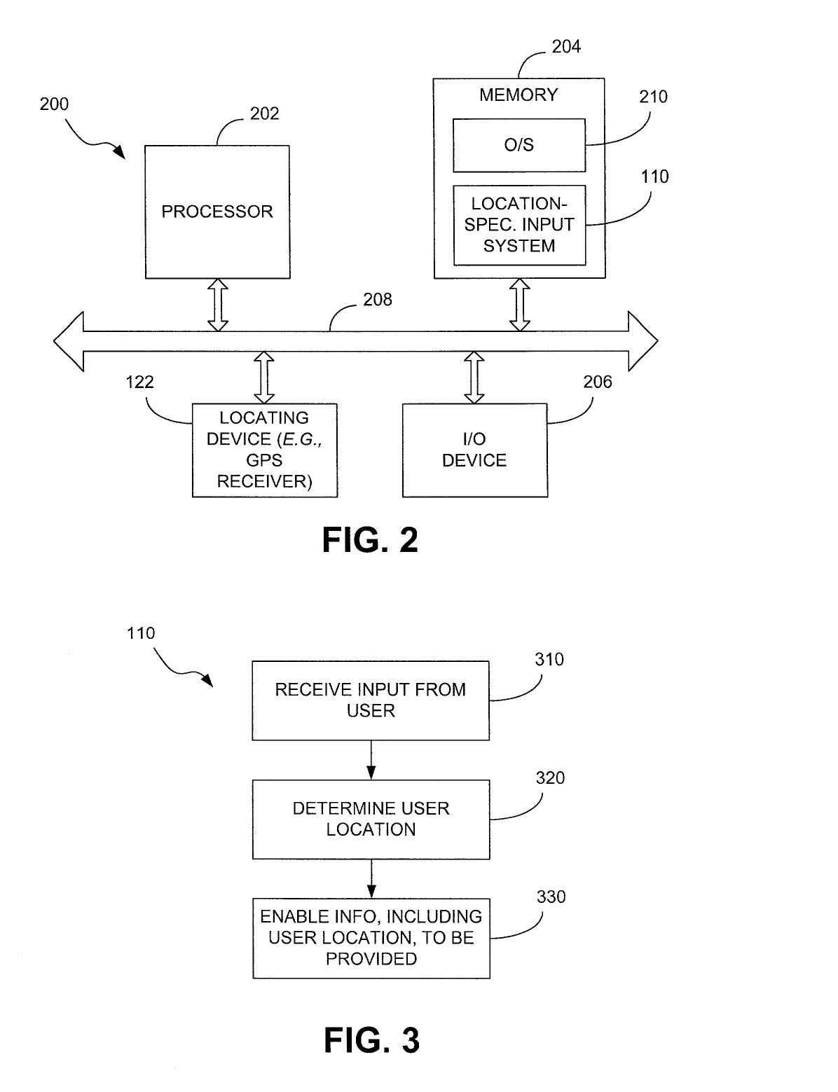

When implemented in software, input system 110 can be a program that is executable by a digital computer, e.g., a computer implemented as or associated with a portable computing device. An example of a portable computing device that can implement input system 110 is shown schematically in FIG. 2.

Generally, in terms of hardware architecture, portable computing device 200, e.g., a laptop, of FIG. 2 includes a processor 202, memory 204, and one or more input and/or output (I/O) devices 206 (or peripherals) that are communicatively coupled via a local interface 208. Local interface 208 can be, for example, one or more buses or other wired or wireless connections, as is known in the art. Local interface 208 can include additional elements, which are omitted for ease of description. These additional elements can be controllers, buffers (caches), drivers, repeaters, and/or receivers, for example. Further, the local interface may include address, control, and/or data connections to enable appropriate communications among the components of portable computing device 200.

Processor 202 can be a hardware device configured to execute software that can be stored in memory 204. Processor 202 can be any custom made or commercially available processor, a central processing unit (CPU) or an auxiliary processor among several processors associated with the portable computing device 200. Additionally, the processor can be a semiconductor-based microprocessor (in the form of a microchip), for example.

Memory 204 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 204 can incorporate electronic, magnetic, optical, and/or other types of storage media. Note that memory 204 can have a distributed architecture, where various components are situated remote from one another, but can be accessed by processor 202.

The software in memory 204 can include one or more separate programs, each of which comprises an ordered listing of executable instructions for implementing logical functions. The software in the memory 204 includes input system 110 and a suitable operating system (O/S) 210. The operating system 210 controls the execution of other computer programs, such as input system 110. Operating system 210 also provides scheduling, input-output control, file and data management, memory management, and communication control and related services.

The I/O device(s) 206 can include input devices such as a keypad, for example. I/O device(s) 206 also can include output devices such as a display device or speaker, for example. I/O device(s) 206 may further include devices that are configured to communicate both inputs and outputs such as a touch screen display, for example. In some embodiments, one such I/O device can be a locating device 122, such as a GPS receiver, that is configured to facilitate determining a location of the portable computing device (described hereinbefore).

When the portable computing device 200 is in operation, processor 202 is configured to execute software stored within the memory 204, communicate data to and from the memory 204, and generally control operations of the portable computing device 200. Input system 110 and the O/S 210, in whole or in part, are read by the processor 202, perhaps buffered within processor 202, and then executed.

When input system 110 is implemented in software, it should be noted that the input system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Input system 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

Reference will now be made to the flowchart of FIG. 3, which depicts the functionality of a representative embodiment of input system 110. In this regard, each block of the flowchart represents a module segment or portion of code that comprises one or more executable instructions for implementing the specified logical function(s). It should also be noted that in some alternative implementations the functions noted in various blocks of FIG. 3, or any other of the accompanying flowcharts, may occur out of the order in which they are depicted. For example, two blocks shown in succession in FIG. 3 may, in fact, be executed substantially concurrently. In other embodiments, the blocks may sometimes be executed in the reverse order depending upon the functionality involved.

As shown in FIG. 3, the functionality of the representative embodiment of the input system or method 110 may be construed as beginning at block 310 where input from a user is received. For example, the input system could receive an input corresponding to the user attempting to access information from a service, e.g., a service implementing and/or associated with a services system. In block 320, the input system determines the user's location, such as by receiving information corresponding to the user's location from a locating device. In other embodiments, the input system could determine the cell location of the user, as described before. Thereafter, such as depicted in block 330, the input system enables information, which preferably includes information corresponding to the location of the user, to be provided to a services system, for example. More specifically, when the input system is implemented in a portable computing device, the input system can enable the information to be provided to a communication network, such as network 120 of FIG. 1, for transmission to an appropriate services system. In response to the information provided by the input system, an appropriately configured services system could then provide information to the user.

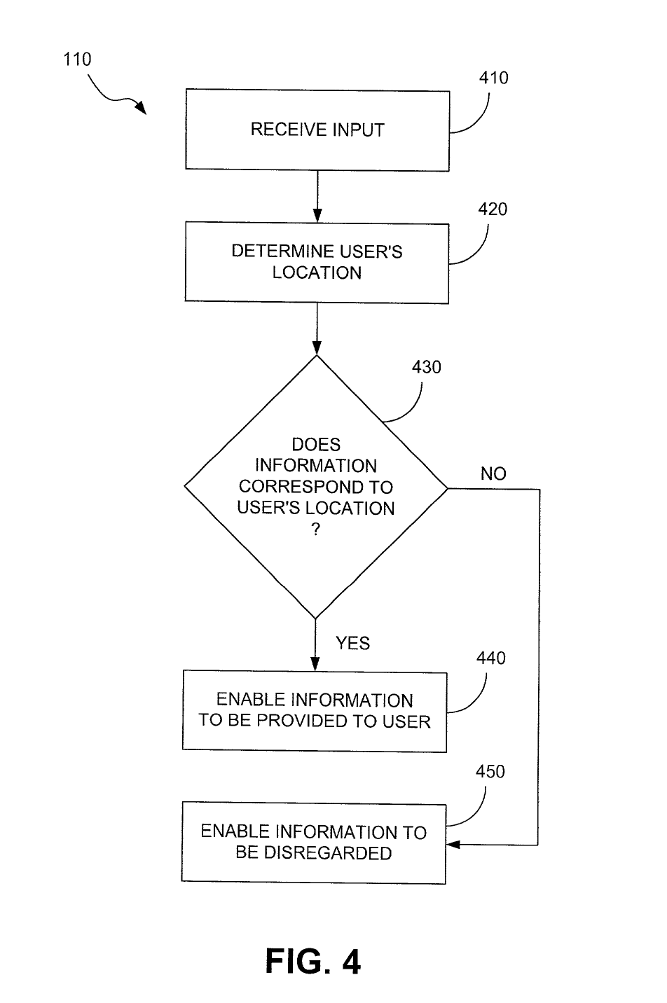

Embodiments of the input system also can perform an information filtering function. In particular, the input system can be adapted to provide information to a user, such as via a portable computing device, if the information corresponds to the user's current location. That is, the input system can filter information that does not correspond to the user's location. The functionality of such an input system is depicted in the representative embodiment of FIG. 4. In FIG. 4, the input system or method 110 can be construed as beginning at block 410 where an input is received. By way of example, the information could be provided to the input system by a services system or any other system that is capable of providing information to the user. In block 420, the input system determines the user's location. Thereafter, such as depicted in block 430, a determination is made as to whether the information received corresponds to the user's location. If it is determined that the information corresponds to the user's location, the process may proceed to block 440, where the information is provided to the user, such as via a display device of a portable computing device. If, however, it is determined that the information does not correspond to the user's location, the process may proceed to block 450, where the information can be disregarded, e.g., not provided to the user.

The aforementioned functionality could be particularly useful when services attempt to “push” or provide unsolicited advertisements and/or information to a user via a portable computing device. In such a scenario, a user could potentially be provided with a tremendous amount of irrelevant information. By using an input system that is adapted for filtering information, the amount of information provided to the user could be dramatically reduced. More specifically, the user may only be provided with information corresponding to the user's location. This reduced amount of information may permit the user to review a larger portion of the received information and, consequently, may result in a more effective advertising strategy for services providing unsolicited information, for example.

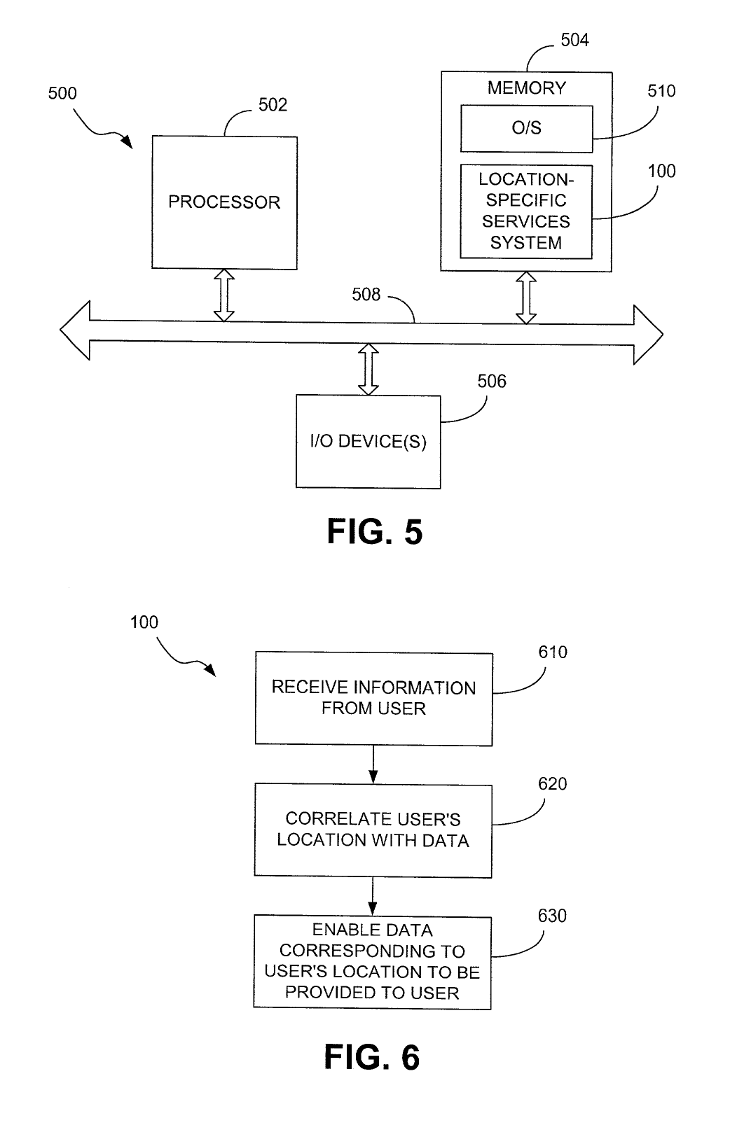

As mentioned before, the ability to provide location-specific information to a user can be accomplished, at least in part, by a services system 100 (FIG. 1). A representative embodiment of services system will now be described with reference to the schematic diagram of FIG. 5. Much like the input system, services system 110 can be implemented in software, firmware, hardware, or a combination thereof. Preferably, services system 110 is implemented in software as an executable program. As such, services system 110 can be executed by a special or general purpose digital computer, such as a personal computer, workstation, minicomputer, or mainframe computer. Typically, the services system is implemented by a server that is configured to receive inputs from and/or provide outputs to various devices, such as portable computing devices (see FIG. 1). An example of a computer that can implement services system 110 is shown schematically in FIG. 5.

Generally, in terms of hardware architecture, computer 500 includes a processor 502, memory 504, and one or more input and/or output (I/O) devices 506 (or peripherals) that are communicatively coupled via a local interface 508. Software in memory 504 can include one or more separate programs, each of which comprises an ordered listing of executable instructions for implementing logical functions. In the example of FIG. 5, the software in the memory 504 includes services system 110 and a suitable operating system (O/S) 510.

The functionality of a representative embodiment of the services system is depicted in the flowchart of FIG. 6. As shown in FIG. 6, services system or method 110 may be construed as beginning at block 610, where information is received from a user. Preferably, the information provided to the services system includes information corresponding to the user's location. In response to receiving the information, the services system attempts to correlate data, which may be stored in a database, for example, with the user's location (block 620). Thereafter, such as depicted in block 630, the services system enables data corresponding to the user's location to be provided to the user. For instance, the information could be provided to the user via a portable computing device.

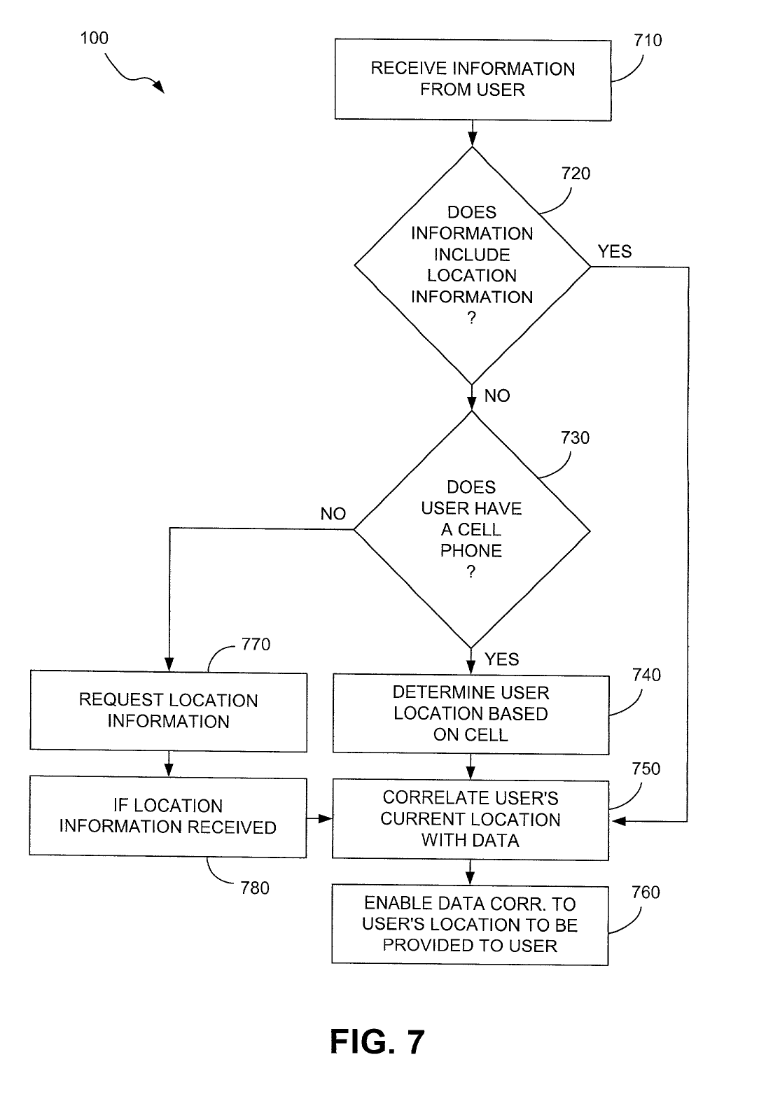

Embodiments of the services system also can be configured to provide location-specific information to a user when the user does not directly communicate information corresponding to the user's location to the services system. Representative functionality of one such embodiment is depicted in the flowchart of FIG. 7. As shown in FIG. 7, services system or method 110 may be construed as beginning at block 710, where information is received from a user. In block 720, a determination is made as to whether the received information includes information corresponding to the user's location. If it is determined that information corresponding to the user's location has not been received, the process may proceed to block 730. At block 730, a determination is made as to whether the user has a cell phone, e.g., whether the information has been provided to the services system via a cell phone. If it is determined that the user has a cell phone, the process may proceed to block 740 where the user's location is determined based on the current cell being utilized by the cell phone. Similar to that described before in relation to the input system, this functionality may involve querying the user's cell phone service provider to determine the user's cell location and/or prompting the user's cell phone to provide information corresponding to the user's current cell.

Regardless of the manner used to determine the user's location, once the location is determined, the process preferably proceeds to block 750 where the user's location is correlated with information, e.g, data that is intended for being provided to user's of the services system. Thereafter, such as depicted in block 760, the services system enables data corresponding to the user's location to be provided to the user. If, however, it was determined in block 730 that the user does not have a cell phone, the process may proceed to block 770 where the services system may request location information from the user. For instance, the services system may provide the user with a selection, e.g., a menu, of locations from which to choose. Thereafter, if location information corresponding to the user is received, the process may proceed to block 750 and proceed as described before. The process also may proceed to block 750 if it was determined in block 720 that the information received from the user includes location information.

Based on the foregoing, it should be appreciated that information systems of the invention can be configured to enable location-specific information to be provided to a user. In some embodiments, the ability of the information system to determine a user's location is facilitated by an input system, which may reside on a portable computing device, and/or a services system, which typically resides on a server. Additionally, providing location-specific information to a user can be accomplished, in some embodiments, by preventing non-location-specific information from being provided to a user.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. For instance, the foregoing description refers to the “user's location.” This term should not be construed to mean only the user's exact geographic position, as some embodiments may be adapted to provide information to a user based on the region occupied by the user. All such modifications and variations, are within the scope of the invention as determined by the appended claims when interpreted in accordance with the breadth to which they are fairly and legally entitled.

1. An information system for use in providing information to a user via a communication network, said information system comprising:
a location-specific input system configured to communicate with a communication network, said location-specific input system being further configured to receive an input from a user, determine a location of the user, and enable information corresponding to the input of the user and the location of the user to be provided to the communication network.

2. The information system of claim 1, further comprising:
a portable computing device, said location-sensitive input system being implemented with said portable computing device.

3. The information system of claim 1, wherein said location-sensitive input system is configured to determine the location of the user automatically in response to receiving the input from the user.

4. The information system of claim 2, wherein said portable computing device is selected from the group consisting of: a phone, a personal digital assistant, and a laptop.

5. The information system of claim 2, wherein said portable computing device includes a Global Positioning System receiver, and the location of the user is determined with said Global Positioning System receiver.

6. The information system of claim 2, wherein the location of the user is determined by said location-specific input system retrieving information corresponding to a current cell with which a cell phone of the user is active.

7. The information system of claim 6, wherein said location-specific input system retrieves information corresponding to the current cell of the user by querying a cell phone service provider of the user.

8. The information system of claim 6, wherein said location-specific input system is implemented by a cell phone of the user, said location-specific input system being configured to retrieve information corresponding to the current cell of the user via the cell phone.

9. The information system of claim 2, wherein said location-specific input system includes means for retrieving information corresponding to a current cell of the user.

10. An information system for use in providing information to a user via a communication network, said information system comprising:
a location-specific input system configured to communicate with a communication network, said location-specific input system being further configured to receive information via the communication network, determine a location of the user, and prevent information failing to correspond to the location of the user from being provided to the user.

11. The information system of claim 10, further comprising:
a portable computing device, said location-sensitive input system being implemented with said portable computing device.

12. The information system of claim 10, wherein the location of the user is determined by said location-specific input system retrieving information corresponding to a current cell with which a cell phone of the user is active.

13. The information system of claim 10, wherein said location-specific input system is configured to determine the location of the user automatically in response to receiving the input from the communication network.

14. An information system for use in providing information to a user via a communication network, said information system comprising:
a location-specific services system configured to communicate with a communication network, said location-specific services system being further configured to receive information from a user via the communication network, determine a location of the user, and provide information which corresponds to the location of the user to the user via the communication network.

15. The information system of claim 14, wherein said location-specific services system is configured to determine the location of the user by retrieving information corresponding to a current cell with which a cell phone of the user is active.

16. The information system of claim 15, wherein said location-specific services system is configured to determine the location of the user by querying a cell phone service provider of the user.

17. A method for providing information to a user via a communication network, said method comprising:
providing a portable computing device;
receiving an input from a user via the portable computing device;
automatically determining a location of the user; and
enabling information corresponding to the input of the user and the location of the user to be provided to the communication network via the portable computing device.

18. The method of claim 17, wherein automatically determining a location of the user comprises:
retrieving information corresponding to a current cell with which a cell phone of the user is active.

19. The method of claim 17, wherein automatically determining a location of the user comprises:
querying a cell phone service provider of the user.

20. A method for providing information to a user via a communication network, said method comprising:
receiving an input from a user;
determining a location of the user; and
providing information corresponding to the input of the user and the location of the user to the user via the communication network.

21. The method of claim 20, wherein determining a location of the user comprises:
retrieving information corresponding to a current cell with which a cell phone of the user is active.

22. The method of claim 20, wherein determining a location of the user comprises:
querying a cell phone service provider of the user.

23. The method of claim 20, wherein receiving an input from a user comprises:
receiving the input from a portable computing device, the portable computing device being configured to determine the location of the user and provide information corresponding to the location of the user via the communication network.

24. The method of claim 20, wherein providing information comprises:
storing information; and
correlating the user input and the location of the user with the stored information.
